(19) United States
(12) Patent Application Publication
(10) Pub. No.: US 2021/0355321 A1
(43) Pub. Date: Nov. 18, 2021

(54) CONDUCTIVE MOULDING COMPOUNDS

(71) Applicant: Evonik Operations GmbH, Essen (DE)

(72) Inventors: Christine Weiß, Dorsten (DE); Olivier Farges, Marl (DE); Franz-Erich Baumann, Dülmen (DE); Klaus Gahlmann, Marl (DE); Michael Böer, Olfen (DE); Andreas Szentivanyi, Essen (DE); Mario Resing, Stadtlohn (DE); Rainer Göring, Borken (DE); Reinhard Linemann, Saarbrücken (DE)

(73) Assignee: Evonik Operations GmbH, Essen (DE)

(21) Appl. No.: 17/284,494

(22) PCT Filed: Oct. 17, 2019
(86) PCT No.: PCT/EP2019/078240

§ 371 Date: Apr. 12, 2021

(30) Foreign Application Priority Data
Oct. 19, 2018 (EP) 18201485.2

(51) Int. Cl. C08L 77/06; C08L 77/02; C08J 3/20; H01B 1/20; B32B 27/34; B32B 27/30; B32B 1/08; B32B 27/08; B32B 27/20; F16L 11/04

(52) U.S. Cl. CPC C08L 77/06; C08L 77/02; C08J 3/201; H01B 1/20; B32B 27/34; B32B 27/306; F02M 37/0011; B32B 27/08; B32B 27/20; F16L 11/04; C08L 2205/025; C08L 2205/12; B32B 1/08

(57) ABSTRACT

The present invention relates to a moulding compound which contains at least 50 wt. % of a semicrystalline poly amide component and the moulding compound contains a filler which imparts conductivity to the moulding compound, wherein the moulding compound does not have a crystallite melting point (Tm) below 50° C. and the polyamide component contains components A and B, A) PA homopolymer of the type PA X.Y or PAZ, where X is a diamine radical (DA), Y is a dicarboxyl radical (DC), and Z is an alpha-omega amino acid radical; B) PA copolymer of the type PA X′.Y′, where X is a diamine radical (DA′) and Y′ is a dicarboxyl radical (DC′); wherein a portion of the diamine radical (DA′) is replaced by a polyether having at least two amino termini or at least two hydroxy termini; wherein the proportion of polyether in the sum of components A and Bis between 0.5 and 15 wt. % and wherein the proportion of filler is 2.5 to 6 wt. % based on the total mass of the poly amide component and the filler. The invention also relates to a method for producing same and using same, and to hollow profiles comprising same.

### CROSS REFERENCE TO RELATED APPLICATIONS

This application is a 35 U.S.C. § 371 U.S. national phase entry of International Application No. PCT/EP2019/078240 having an international filing date of Oct. 17, 2019, which claims the benefit of European Application No. 18201485.2 filed Oct. 19, 2018, both of which are incorporated herein by reference in its entirety.

### FIELD

The invention is directed to semicrystalline polyamide components as a constituent of moulding compounds, wherein the polyamide component does not have a crystallite melting point (Tm) below 50° C.

### BACKGROUND

Flexible pipes which are used for routing of liquid or gaseous media in motor vehicles are well known. This problem was formerly solved satisfactorily by means of monolayer pipes made of polyamide or other thermoplastic moulding compounds. In the case of these monolayer pipes, it was found that the mechanical properties that exist after installation, such as high elongation at break and high impact resistance, even over the lifetime of the motor vehicle, are not so significantly altered by the effects of cold or heat or by contact with media as to result in failure of the conduit.

Stricter environmental regulations have led to a move away from the further development and use of monolayer pipes for use as a fuel line and from single-layer fuel vessels. In both cases, the automobile industry requires not only adequate fuel resistance but also an improved barrier effect with respect to the fuel components, in order to reduce the emissions thereof. This has led to the development of multilayer hollow bodies in which a barrier layer material is used. Multilayer composites of this kind, which comprise not only a barrier layer but also further layers based on aliphatic polyamides, are known, for example, from EP 1216826 A2.

Because of their good mechanical properties, their low water absorption capacity and their insensitivity toward environmental influences, polyamides are a useful material both for the inner layer and for the outer layer. Adhesion between adjoining layers is desirable and can be assured with an intervening adhesion promoter layer. In the automobile industry, there has additionally for some time been a trend toward higher temperatures in the engine compartment and hence a demand for stability of the hollow bodies used at these temperatures. Solutions including an adhesion promoter layer based, for example, on polyolefins are unsuitable because of their low heat distortion resistance. EP1216826A2 solves this problem through use of an adhesion-promoting layer comprising a polyamide selected from PA6, PA66 and PA6/66, optionally a polyamine-polyamide copolymer, and a polyamide selected from PA11, PA12, PA612, PA1012 and PA1212.

The advancing trend of “downsizing”, i.e. the reduction of component sizes while maintaining the same performance with the aim of lowering energy consumption of motor vehicle engines, for example, is leading not only to an increase in the temperatures that prevail in the engine compartment but also to a reduction in the size of the injection valves. These valves are nozzles which inject fuel into the intake tract or the combustion chamber of an internal combustion engine. Polar constituents present in fuels require that the multilayer pipe used be resistant to extraction of constituents from the materials used. U.S. Pat. No. 6,467,508 describes the precipitation of such extracts in the fuel and the possible blockage of the injection valves as a problem. This problem is solved by the use of a “low precipitate polyamide” in the inner layer. The “low precipitate polyamide” is washed polyamide which is obtained by inconvenient and costly preceding extraction with methanol. In this way, troublesome constituents, for example oligomers, are removed.

Following the progressive decrease in size of the injection nozzles, the automobile industry is also demanding not only the reduction of the extracts that precipitate out in the fuel, but also a reduction in the extracts that are soluble in the fuel. Because of the introduction of hybrid vehicles, this demand has been enhanced, since the internal combustion engine in these vehicles is not used for prolonged periods. Soluble extracts in the fuel can thus also lead, via drying-out, to blockage of injection nozzles. Extracts are not only the oligomers described in U.S. Pat. No. 6,467,508, but also additives, for example plasticizers and stabilizers of the moulding compounds used.

Both in DE 3 724 997 C2 and DE 2 716 004 C3 and in EP 0 566 755 B1, polyether-block-amides with laurolactam as monomer are used for the polyamide block. Corresponding modified mixtures with nylon-12 are also mentioned in Polyamid-Kunststoffhandbuch [Plastics Handbook—Polyamide], 3/4, 1998, Carl Hanser Verlag, on page 872, paragraph 8.3.3. These blends show partial compatibility based on the cocrystallization of the nylon-12 blocks with the homopolyamide.

EP1884356 discloses blends of polyamide/polyamide elastomers (TPE-A); the addition of conductivity additives is also mentioned in a list of possible additives. The blends disclosed contain both large amounts of polyetheramides and large amounts of impact modifiers based on polyolefins.

The preparation of polyetheramides is described, for example, in EP0459862B1 and CH642982. The polyetheramides are prepared here proceeding from polyamide sequences having carboxyl groups at both chain ends with polyoxyalkylene sequences having amino groups at both chain ends.

WO 2017/121961 A1 and WO 2017/121962 A1 claim multilayer pipes, wherein the inner layers have at least three different polyamides with different chain lengths. These layers may also include polyether-block-amides; they may also be conductive.

Typical thermoplastics have specific surface resistances in the range from 10¹⁶ to 10¹⁴ ohms (Ω) and can therefore build up voltages of up to 15 000 volts. Effective antistats can reduce the specific surface resistances of the plastics to 10¹⁰ to 10⁹ ohms. A much higher level for the dissipation of electrostatic charges must be achieved, by contrast, if plastics are to be used in electronic components of large devices, for example in the transformer or electrical switchgear manufacture sector, or in a multitude of applications in automobile and aircraft construction. It is necessary here to use electrically conductive moulding compounds that must have a specific surface resistance of less than 10⁹ ohms. What is additionally crucial is that, in such plastics applications, not just the surface resistance but also the volume resistance through plastics parts having a thickness of up to several millimeters must be within the very same range and, in the case of parts that are produced by means of injection moulding, there is frequently development of anisotropy effects that are generally difficult to prevent.

For the manufacture of conductive plastics parts, it is therefore only possible either to use plastics that are already conductive, such as polyanilines inter alia, or to render the aforementioned plastics that can be characterized as electrical insulators conductive through the use of carbon blacks, especially conductive blacks, carbon fibers, graphite, graphene and/or carbon nanotubes (CNTs).

Carbon nanotubes, alongside graphite, diamond, amorphous carbon and fullerenes, are a further polymorph of the element carbon. The carbon atoms are arranged here in hexagons. The structure corresponds to a rolled-up monoatomic or multiatomic layer of graphite, so as to form a hollow cylinder with diameters typically of a few nanometers and length up to a few millimeters. A basic distinction is made between multiwall and single-wall carbon nanotubes, usually also abbreviated in the literature as MWNTs and SWNTs. Owing to van der Waals forces, carbon nanotubes have a strong tendency to combine to form bundles, and therefore disentangling/dispersion without significant shortening by strong shear forces in the extrusion process is essential. Typical commercial products are available from various manufacturers, of which the following are mentioned here by way of example: Bayer, Cyclics (formerly Electrovac), Nanocyl and Arkema with their Baytubes® C150P (trademark of Bayer AG, Germany), Baytubes C 150 HP, Baytubes C 70P, Electrovac HTF 110 FF, Nanocyl® NC 7000 (trademark of Nanocyl SA, Belgium) and Graphistrength C100 grades. Further manufacturers supply CMTs in the form of masterbatches, for example Hyperion and C-Polymers.

### SUMMARY

Accordingly, the problem addressed by the invention is that of providing conductive moulding compounds that do not require any plasticizers of low molecular weight or other extractable substances to improve mechanical properties and improve ageing resistance.

This problem is solved by semicrystalline polyamide components as a constituent of moulding compounds, wherein the polyamide component does not have a crystallite melting point (Tₘ) below 50° C. as described in detail hereinafter and in the claims.

### DETAILED DESCRIPTION

The invention provides a moulding compound comprising at least 50% by weight, preferably 60% by weight, more preferably 70% by weight, particularly preferably 80% by weight and especially preferably at least 90% by weight of a semicrystalline polyamide component and comprising a filler that imparts conductivity to the moulding compound, characterized in that the moulding compound does not have a crystallite melting point below 50° C.,

where the polyamide component comprises components A and B
A PA homopolymer of the PA X.Y or PA Z type, where X represents a diamine residue (DA), Y represents a dicarboxyl residue (DC), and Z represents an alpha,omega-amino acid residue;
B PA copolymer of the PA X′.Y′ type where X′ represents a diamine residue (DA′) and Y′ represents a dicarboxyl residue (DC′);
   where some of the diamine residues (DA′) are replaced by a polyether having at least two amino termini or at least two hydroxy termini;
   where the proportion of polyether in the sum total of components A and B is between 0.5% and 15% by weight
   and where the proportion of filler is from 2.5% to 6% by weight, based on the total mass of polyamide component and filler,
   where up to 10 mol % of the PA homopolymer may be formed from other amide-forming units,
   where up to 10 mol % of the diamine residues (DA′) may be replaced by a polyether having just one amino terminus or just one hydroxy terminus.

The invention further provides for the use of the moulding compound according to the invention for production of hollow profiles.

The invention further provides single-layer or multilayer hollow profiles having at least one layer consisting of the moulding compound according to the invention.

The moulding compounds and shaped bodies according to the invention (such as hollow profiles) that comprise the moulding compounds of the invention and the use according to the invention are described by way of example hereinafter, without any intention that the invention be restricted to these illustrative embodiments. Where ranges, general formulae, or classes of compound are stated below, these are intended to comprise not only the corresponding ranges or groups of compounds explicitly mentioned, but also all subranges and subgroups of compounds which can be obtained by extracting individual values (ranges) or compounds. Where documents are cited within the context of the present description, the entire content thereof is intended to be part of the disclosure of the present invention. Where percentage figures are given hereinafter, unless stated otherwise, these are figures in % by weight. In the case of compositions, the percentage figures are based on the entire composition unless otherwise stated. Where average values are given hereinafter, unless stated otherwise, these are mass averages (weight averages). Where measured values are given hereinafter, unless stated otherwise, these measured values were determined at a pressure of 101 325 Pa and at a temperature of 25° C.

The scope of protection includes finished and packaged forms of the products according to the invention that are customary in commerce, both as such and in any forms of reduced size, to the extent that these are not defined in the claims.

The different units of the polyether are in a statistical distribution. Statistical distributions are of blockwise construction with any desired number of blocks and with any desired sequence or they are subject to a randomized distribution; they may also have an alternating construction or else form a gradient over the polymer chain; more particularly they can also form any mixed forms in which groups with different distributions may optionally follow one another. Specific embodiments may lead to restrictions to the statistical distributions as a result of the embodiment. There is no change in the statistical distribution for all regions unaffected by the restriction.

One advantage of the moulding compounds according to the invention is that a single-layer or multilayer hollow body having an inner layer consisting of the moulding compound according to the invention has a high washout resistance. This is shown by a test with a test fuel according to ASTM D471-15, “Reference Fuel I”, on a tube as described in the examples. It is a feature of the test fuel that it contains 15% by volume of methanol. Further methods of determination for washout resistance may be known in the art; the method preferred in accordance with the invention is detailed in the examples. It is possible here to extract soluble components and also insoluble components. Preferably, less than 6 g per square meter of inner area of the test specimen of soluble components is extracted from the test specimen, preferably less than 5.5 g/m².

A further advantage of the moulding compounds according to the invention is that the degree of crystallinity of the polyamide component consisting of components A, B and C is lower than the degree of crystallinity of a mixture including the same components A and C in the same amounts.

An advantage of the multilayer hollow bodies according to the invention that have an inner layer formed from the moulding compound according to the invention and have a barrier layer is low fuel permeability. This is shown by a test with a test fuel according to ASTM D471-15, “Reference Fuel I”, on a tube as described in the examples. It is a feature of the test fuel that it contains 15% by volume of methanol. Further methods of determination for washout resistance may be known in the art; the method preferred in accordance with the invention is detailed in the examples.

There is preferably diffusion of not more than 6 g/m² out of the test specimen on storage at 60° C. within the test duration of one day, preferably less than 5.5 g/m², more preferably less than 5.0 g/m² and especially preferably less than 4.5 g/m².

Amide-forming units are alpha,omega-amino acid residues or the combination of diamine residues with dicarboxyl residues. Preferred alpha,omega-amino acid residues are free amino acids or lactams thereof, more preferably epsilon-caprolactam, 11-aminoundecanoic acid, 12-aminolauric acid or the corresponding laurolactam.

Diamine residues are residues having a hydrocarbon bearing an amino group at each terminal end, where the amino group may form the terminus of the polymer, but generally contributes with a valence to chain formation.

Preferred hydrocarbons are aliphatic, more preferably having 2 to 18 carbon atoms, particularly preferably 3 to 14 carbon atoms, especially preferably 4 to 12 carbon atoms. If the hydrocarbons have more than 3 carbon atoms, these are linear, branched or cyclic, preferably linear, more preferably linear up to a number of 6 carbon atoms.

Particularly preferred diamine residues are ethylenediamine, 1,4-diaminobutane, 1,6-diaminohexane, 1,10-diaminodecane, 1,12-diaminododecane; especially preferably 1,6-diaminohexane.

Dicarboxyl residues (DC) are residues having a hydrocarbon bearing a carboxyl group at each terminal end, where the carboxyl group may form the terminus of the polymer, but generally contributes as a carbonyl group with a valence to chain formation.

Preferred hydrocarbons are aliphatic, more preferably having 3 to 18 carbon atoms, particularly preferably having 6 to 14 carbon atoms, especially preferably having 8 to 12 carbon atoms. The hydrocarbons are further preferably linear, branched or cyclic, more preferably linear.

Preferred dicarboxyl residues are residues of succinic acid, glutaric acid, adipic acid, pimelic acid, suberic acid, azelaic acid, sebacic acid, dodecanedioic acid, especially preferably of dodecanedioic acid.

The PA homopolymer includes polyamides (PA) for component A; preferred polyamides are PA 6, PA 11, PA 12, PA 4.6, PA 6.6 PA 6.9, PA 6.10, PA 6.12, PA 9.10, PA 9.12, PA 10.10, PA 10.12, PA 12.12; more preferably PA 6.6, PA 6.10, PA 6.12, PA 10.10; particularly preferably

PA 6.10, PA 6.12, PA 10.10 and especially preferably PA 6.12.

The PA copolymer of component B preferably has a polyether content of 8% to 30% by weight, more preferably of 9% to 25% by weight, particularly preferably 10% to 20% by weight, especially preferably 12% to 18% by weight, based on the total mass of the PA copolymer.

The polyether preferably has 3 up to 50 repeat units, more preferably 4 to 40, particularly preferably 5 to 30, especially preferably 6 to 20, where the repeat units are joined to one another by oxygen atoms.

The polyether is preferably free of nitrogen atoms that do not have any hydrogen atoms, and is further preferably free of amino groups of the formula —NH—, ═NH in the polymer chain.

More preferably, the polyether has exclusively alkyleneoxy units; preferably, if alkyleneoxy units having 3 to 18 carbon atoms are present, the polymer has tacticity, i.e. is isotactic, syndiotactic, heterotactic, hemiisotactic, atactic.

Particularly preferred polyethers consist of ethyleneoxy, propyleneoxy and butyleneoxy units or mixtures thereof, where the mixtures are random. Especially preferred polyethers consist of ethyleneoxy and propyleneoxy units, or consist of n-butyleneoxy units, or consist of propyleneoxy units.

The polyether preferably has a number-average molecular weight Mn of not more than 5000 g/mol, particularly preferably of not more than 2000 g/mol and especially preferably of not more than 1000 g/mol, where the lower limit is at least 200 g/mol, preferably 300 g/mol, more preferably 400 g/mol.

The polyether preferably does not have more than two amino termini or two hydroxy termini, and more preferably has exactly two amino termini or two hydroxy termini.

The polyamide component of the moulding compounds according to the invention preferably has a polyether content of 1% to 12% by weight, preferably 1.5% to 9% by weight, particularly preferably 2.0% to 8% by weight, especially preferably 2.5% to 7% by weight, based on the total mass of components A and B.

The chain lengths of the PA copolymer and of the PA homopolymer of the polyamide component preferably differ from one another by an average of not more than 10% in relation to the number of carbon atoms in the amide-forming units, where the difference is based on the higher value of the chain lengths. In the case of use of a PA copolymer PA 10.12 and the PA homopolymer, e.g. a PA 10.10, the average of the PA 10.12 is 11 and the difference is thus 9.1%.

The moulding compounds according to the invention have a proportion of filler for increasing conductivity (component C) of 2.5% to 6% by weight, based on the total mass of the polyamide component and the filler for increasing conductivity, i.e. the sum total of components A, B and C. The lower limit of 2.5% by weight here has the advantage that the conductivities are sufficiently high and the resistances are sufficiently low to enable use in electronic components of large equipment and in automobile and aircraft construction. Filler concentrations greater than 6% by weight further result in small notched impact resistances that show embrittlement of the material at excessively high filler concentrations.

Preferred fillers for increasing conductivity do not form aggregates; they are thus dispersible with introduction of shear forces.

Further preferably, the moulding compounds according to the invention have a degree of crystallinity lower than the degree of crystallinity of a mixture including the same components A and C (filler for increasing conductivity) in equal amounts, where any further constituents of the moulding compound are likewise identical in identity and amount.

The degree of crystallinity is determined by the prior art methods; the degree of crystallinity is preferably calculated by equation (1)

$${X}_{C} = \frac{Δ {H}_{m}}{Δ {H}_{m}^{0}} \qquad ( E1 )$$

The parameters Tₘ, T_{g} and ΔHₘ within the scope of the present invention are determined with the aid of DSC, preferably according to EN ISO 11354-1:2016D, more preferably as described in the examples.

The values ΔHₘ⁰ for calculation of the degree of crystallinity Xc are taken from tabular works, for example van Krevelen “Properties of Polymers”, 4th edition, 2009. The following values are preferably assumed:

| Polyamide | ΔHₘ⁰ | T_{g} | Tₘ |
|---|---|---|---|
| PA 6 | 230 | 40 | 260 |
| PA 11 | 226 | 46 | 220 |
| PA 12 | 210 | 37 | 179 |
| PA 6.6 | 300 | 50 | 280 |
| PA 6.10 | 260 | 50 | 233 |
| PA 6.12 | 215 | 54 | 215 |
| PA 10.9 | 250 | | 214 |
| PA 10.10 | 200 | 60 | 216 |

The moulding compounds according to the invention preferably do not show any addition of ionic liquids for increasing conductivity, as described, for example, in EP2635638A1 (US20130299750A1). Further preferably, the moulding compounds according to the invention do not include any metals in elemental form.

Preferably, the moulding compounds according to the invention are free of plasticizers, preferably of plasticizers of low molecular weight. Plasticizers in this context are listed in DIN EN ISO 1043-3:2017, and also, for example, esters of p-hydroxybenzoic acid having 2 to 20 carbon atoms in the alcohol component or amides of arylsulfonic acids having 2 to 12 carbon atoms in the amine component, preferably amides of benzenesulfonic acid; ethyl p-hydroxybenzoate, octyl p-hydroxybenzoate, i-hexadecyl p-hydroxybenzoate, N-n-octyltoluenesulfonamide, N-n-butylbenzenesulfonamide or N-2-ethylhexylbenzenesulfonamide.

The moulding compound according to the invention is produced from the individual constituents preferably by melt mixing in a kneading unit, i.e. with employment of shear forces.

The present invention thus also provides a process for producing the moulding composition according to the invention, in which the individual constituents are mixed by melt mixing.

The individual components of the composition according to the invention may be added here simultaneously or successively. Even though, in preferred embodiments, the filler can first be dispersed in component A or B (especially in component B) in the context of masterbatch production, in which case the masterbatch produced is subsequently diluted with the respective component B or A not present in the masterbatch, very particular preference is given to a process for producing the moulding composition according to the invention in which the individual constituents A and B and the filler are mixed simultaneously by melt mixing. Any further constituents of the moulding compound of the invention can be added at the same time as components A and B and filler or thereafter.

Preferred carbon nanotubes typically take the form of tubes formed from graphite layers. The graphite laminas are arranged in a concentric manner about the cylinder axis. Carbon nanotubes are also referred to as carbon nanofibrils. They have a length-to-diameter ratio of at least 5, preferably of at least 100, more preferably of at least 1000. The diameter of the nanofibrils is typically in the range from 0.003 to 0.5 μm, preferably in the range from 0.005 to 0.08 μm, more preferably in the range from 0.006 to 0.05 μm. The length of the carbon nanofibrils is typically 0.5 to 1000 μm, preferably 0.8 to 100 μm, more preferably 1 to 10 μm. The carbon nanofibrils have a hollow, cylindrical core. This cavity typically has a diameter of 0.001 to 0.1 μm, preferably a diameter of 0.008 to 0.015 μm. In a typical embodiment of the carbon nanotubes, the wall of the fibrils around the cavity consists, for example, of 8 graphite laminas. The carbon nanofibrils may take the form here of agglomerates of up to 1000 μm in diameter, composed of multiple nanofibrils. The agglomerates may have the form of birds' nests, of combed yarn or of open mesh structures. The carbon nanotubes are synthesized, for example, in a reactor containing a carbon-containing gas and a metal catalyst, as described, for example, in U.S. Pat. No. 5,643,502A.

As well as multiwall carbon nanotubes (MWCNTs), it is also possible in accordance with the invention to use single-wall carbon nanotubes (SWCNTs). SWCNTs typically have a diameter in the region of a few nanometers, but reach considerable lengths in relation to their cross section, typically in the region of several micrometers. The structure of SWCNTs derives from monoatomic graphite laminas (graphene) that can be imagined as having been rolled up to form a seamless cylinder. SWCNTs can be excellent electrical conductors. The attainable current densities, at 10⁹ A/cm², are about 1000 times higher than in the case of metal wires of copper or silver. The production of SWCNTs is described, for example, in U.S. Pat. No. 5,424,054.

Preference is further given to a moulding compound comprising at least 70% by weight, particularly preferably 80% by weight and especially preferably at least 90% by weight of a semicrystalline polyamide component and comprising a filler that imparts conductivity to the moulding compound, characterized in that the moulding compound does not have a crystallite melting point below 50° C.,

where the polyamide component comprises components A and B
A PA homopolymer of the PA X.Y or PA Z type, where X represents a diamine residue (DA), Y represents a dicarboxyl residue (DC), and Z represents an alpha,omega-amino acid residue;
B PA copolymer of the PA X′.Y′ type where X′ represents a diamine residue (DA′) and Y′ represents a dicarboxyl residue (DC′);
   where some of the diamine residues (DA′) are replaced by a polyether having two amino termini or two hydroxy termini;
   where the proportion of polyether in the sum total of components A and B is between 0.5% and 15% by weight
   and where the proportion of filler is from 2.5% to 6% by weight, based on the total mass of polyamide component and filler;
   where up to 10 mol % of the PA homopolymer may be formed from other amide-forming units;
   where the PA copolymer of component B has a polyether content of 8% to 30% by weight, based on the total mass of the PA copolymer.

Preference is further given to a moulding compound comprising at least 70% by weight, particularly preferably 80% by weight and especially preferably at least 90% by weight of a semicrystalline polyamide component and comprising a filler that imparts conductivity to the moulding compound, characterized in that the moulding compound does not have a crystallite melting point below 50° C.,

where the polyamide component comprises components A and B
A PA homopolymer of the PA X.Y or PA Z type, where X represents a diamine residue (DA), Y represents a dicarboxyl residue (DC), and Z represents an alpha,omega-amino acid residue;
B PA copolymer of the PA X′.Y′ type where X′ represents a diamine residue (DA′) and Y′ represents a dicarboxyl residue (DC′);
   where some of the diamine residues (DA′) are replaced by a polyether having two amino termini or two hydroxy termini;
   where the proportion of polyether in the sum total of components A and B is between 0.5% and 15% by weight
   and where the proportion of filler is from 2.5% to 6% by weight, based on the total mass of polyamide component and filler;
   where up to 10 mol % of the PA homopolymer may be formed from other amide-forming units;
   where the polyether has a number-average molecular weight Mₙ of not more than 5000 g/mol;
   where the chain lengths of the PA copolymer and of the PA homopolymer of the polyamide component differ from one another by an average of not more than 10% in relation to the number of carbon atoms in the amide-forming units, where the difference is based on the higher value of the chain lengths.

Preference is further given to a moulding compound comprising at least 70% by weight, particularly preferably 80% by weight and especially preferably at least 90% by weight of a semicrystalline polyamide component and comprising a filler that imparts conductivity to the moulding compound, characterized in that the moulding compound does not have a crystallite melting point below 50° C.,

where the polyamide component comprises components A and B
A PA homopolymer is selected from PA 6, PA 11, PA 12, PA 4.6, PA 6.6, PA 6.9, PA 6.10, PA 6.12, PA 9.10, PA 9.12, PA 10.10, PA 10.12, PA 12.12;
B PA copolymer of the PA X′.Y′ type where X′ represents a diamine residue (DA′) and Y′ represents a dicarboxyl residue (DC′);
   where some of the diamine residues (DA′) are replaced by a polyether having two amino termini or two hydroxy termini;
   where the proportion of polyether in the sum total of components A and B is between 0.5% and 15% by weight
   and where the proportion of filler is from 2.5% to 6% by weight, based on the total mass of polyamide component and filler;
   where up to 10 mol % of the PA homopolymer may be formed from other amide-forming units;
   where the moulding compound has a degree of crystallinity lower than the degree of crystallinity of a mixture including the same components A and filler for increasing conductivity in equal amounts, where any further constituents of the moulding compound are likewise identical in identity and amount.

The moulding compounds according to the invention preferably contain further additives.

Preferred additives are oxidation stabilizers, UV stabilizer, hydrolysis stabilizers, impact modifiers, pigments, dyes and/or processing aids.

In a preferred embodiment, the moulding compounds comprise an effective amount of an oxidation stabilizer and more preferably an effective amount of an oxidation stabilizer in combination with the effective amount of a copper-containing stabilizer. Examples of suitable oxidation stabilizers include aromatic amines, sterically hindered phenols, phosphites, phosphonites, thiosynergists, hydroxylamines, benzofuranone derivatives, acryloyl-modified phenols etc. A great many types of such oxidation stabilizers are commercially available, for example under the trade names Naugard 445, Irganox 1010, Irganox 1098, Irgafos 168, P-EPQ or Lowinox DSTDP. In general, the moulding compounds contain about 0.01% to about 2% by weight and preferably about 0.1% to about 1.5% by weight of an oxidation stabilizer.

In addition, the moulding compounds may also comprise a UV stabilizer or a light stabilizer of the HALS type. Suitable UV stabilizers are primarily organic UV absorbers, for example benzophenone derivatives, benzotriazole derivatives, oxalanilides or phenyltriazines. Light stabilizers of the HALS type are tetramethylpiperidine derivatives; these are inhibitors which act as radical scavengers. UV stabilizers and light stabilizers may advantageously be used in combination. A great many types of both are commercially available; the manufacturer's instructions can be followed in respect of the dosage.

The moulding compounds may additionally comprise a hydrolysis stabilizer, for instance a monomeric, oligomeric or polymeric carbodiimide or a bisoxazoline.

The moulding compounds may further comprise impact modifiers. Impact-modifying rubbers for polyamide moulding compounds form part of the prior art. They contain functional groups which originate from unsaturated functional compounds that are either included in the main chain polymer or grafted onto the main chain. The most commonly used are EPM or EPDM rubber which has been free-radically grafted with maleic anhydride. Rubbers of this kind can also be used together with an unfunctionalized polyolefin, for example isotactic polypropylene, as described in EP0683210A2 (U.S. Pat. No. 5,874,176A).

Examples of suitable pigments and/or dyes include iron oxide, zinc sulfide, ultramarine, nigrosin, pearlescent pigments.

Examples of suitable processing aids include paraffins, fatty alcohols, fatty acid amides, stearates such as calcium stearate, paraffin waxes, montanates or polysiloxanes.

Multilayer hollow profiles according to the invention have at least one layer produced from the moulding compounds according to the invention which is in direct contact with a liquid. This is preferably the innermost layer of the hollow body.

The liquid is preferably a mixture of chemical substances comprising hydrocarbons and at least one alcohol; the liquid is more preferably a fuel suitable as power fuel for internal combustion engines; the fuel is especially preferably a motor vehicle fuel, for example diesel or gasoline.

The fuel preferably comprises alcohols having 1 to 8 carbon atoms, more preferably methanol, ethanol, propanol, butanol or pentanol. The alcohols having at least three carbon atoms may be in their n form, i.e. linear and with a terminal hydroxyl group, or in their various iso forms; the hydroxyl group here may be primary, secondary or tertiary, preferably primary. More preferably, at least 80% by volume of the alcohols are linear hydrocarbons having a terminal hydroxyl group.

The fuels preferably include at least 7% by volume, more preferably at least 10% by volume, particularly preferably at least 13% by volume, especially preferably at least 16% by volume, of alcohol.

The single- or multilayer hollow body according to the invention is preferably a pipe or vessel, preferably a component of a fuel-conducting system, preferably a fuel line or a fuel tank.

The layer produced from the moulding compounds according to the invention which is preferably in contact with the liquid is electrically conductive. The hollow body has a specific surface resistivity of not more than 10⁹ Ω/square and preferably not more than 10⁶ Ω/square. Suitable test methods are known in the prior art; preference is given to determining specific surface resistivity as elucidated in SAE J 2260 of November 2004.

A preferred multilayer hollow body according to the invention has what is called a barrier layer. This barrier layer has a very low coefficient of diffusion for the fuel components. Suitable materials for the barrier layer are hydrofluorocarbons and vinyl alcohol polymers. The preferably multilayer hollow body preferably has what is called an EVOH barrier layer. EVOH is a copolymer of ethylene and vinyl alcohol. The ethylene content in the copolymer is preferably 20 to 45 mol % and especially 25 to 35 mol %. A multitude of grades are commercially available. Reference is made by way of example to the company brochure “Introduction to Kuraray EVAL™ Resins”, Version 1.2/9810 from Kuraray EVAL Europe. The barrier layer may, in addition to the EVOH according to the prior art, contain further additives as customary for barrier layer applications. Additives of this kind are generally part of the know-how of the EVOH supplier.

The preferred multilayer hollow body according to the invention has a barrier layer (SpS) and, as innermost layer (Si), a layer produced from the moulding compounds according to the invention, where the hollow body has a specific surface resistivity of not more than not more than 10⁶ Ω/square to SAE J 2260 of November 2004.

Between the barrier layer (SpS) and the innermost layer (Si) of the preferred multilayer hollow body may be disposed further layers, preferably at least one layer (HVi) that assures adhesion between Si and SpS. Preferably, there is solely an adhesion promoter layer arranged between SpS and Si. If the adhesion between SpS and Si should be sufficiently great, it is of course possible to dispense with the adhesion-promoting layer (HVi).

Adhesion promoters between the barrier layer and the layer of the moulding compound according to the invention are known to those skilled in the art; preferred adhesion promoters are based on polyamides, preferably composed of mixtures of PA 6.12 and PA 6, more preferably composed of impact-modified polyamides and especially preferably comprising 60% to 80% by weight of PA 6.12, 10% to 25% by weight of PA 6 and 5% to 15% by weight of impact modifier, where the proportions by mass are chosen so as to add up to 100% by weight.

Preferably, layers disposed on the inside of the barrier layer in the preferred hollow body according to the invention are free of plasticizers as defined above. Further preferably, these layers include only the exact amount of additives needed, for example stabilizers and processing aids.

The preferred hollow body according to the invention preferably has at least one further layer on the outside of the barrier layer. These outer layers are preferably likewise layers including at least 50% by weight, more preferably at least 60% by weight, even more preferably at least 70% by weight, particularly preferably at least 80% by weight and especially preferably at least 90% by weight of polyamides.

These polyamides are preferably PA homopolymers of the PA X.Y or PAZ type as already described above. Preferably, the PA homopolymer of the outer layer (Sa) of the preferred hollow body is not identical to that of the innermost layer (Si). Preferably, the PA homopolymer of the outer layer (Sa) is a PA of the PAZ type, more preferably a PA11 or PA12, especially preferably a PA12.

Between the outer layer (Sa) and the barrier layer (SpS) of the preferred hollow body according to the invention may be disposed further layers, preferably at least one layer (HVa) that assures adhesion between Sa and SpS. Preferably, there is solely an adhesion promoter layer arranged between Sa and SpS. If the adhesion between Sa and SpS should be sufficiently great, it is of course possible to dispense with the adhesion-promoting layer (HVa).

The adhesion-promoting layer (HVa) is preferably free of plasticizers as defined above. Further preferably, this layer includes only the exact amount of additives needed, for example stabilizers and processing aids.

Preferably, the adhesion promoter layers HVi and HVa are identical in terms of their chemical composition.

Preference is further given to multilayer hollow profiles having at least one layer consisting of the moulding compound according to the invention, where this layer is in direct contact with a liquid, and additionally having at least one barrier layer.

Preference is further given to multilayer hollow profiles having at least one layer consisting of the moulding compound according to the invention, and additionally having at least one barrier layer of hydrofluorocarbons or vinyl alcohol polymers; where layers disposed on the inside of the barrier layer in the hollow body are free of plasticizers.

The hollow profile according to the invention may also be ensheathed by an additional elastomer layer. Both crosslinking rubber compositions and thermoplastic elastomers are suitable for the sheathing. The sheathing may be applied to the multilayer composite either with or without the use of an additional adhesion promoter, for example by coextrusion, extrusion through a crosshead die or by sliding a prefabricated elastomer hose over the ready-extruded multilayer pipe. The sheathing generally has a thickness of 0.1 to 4 mm and preferably of 0.2 to 3 mm.

Examples of suitable elastomers include chloroprene rubber, ethylene-propylene rubber (EPM), ethylene-propylene-diene rubber (EPDM), epichlorohydrin rubber (ECO), chlorinated polyethylene, acrylate rubber, chlorosulfonated polyethylene, silicone rubber, plasticized PVC, polyetheresteramides or polyetheramides.

The multilayer composite may be fabricated in one or more stages, for example by a single-stage process by means of sandwich moulding, coextrusion, coextrusion blow moulding (for example including 3D blow moulding, extrusion of a parison into an open half-mould, 3D parison manipulation, suction blow moulding, 3D suction blow moulding, sequential blow moulding) or by multistage processes as described in U.S. Pat. No. 5,554,425 for example.

The invention is to be elucidated by way of example in the Experimental which follows.

In the examples, the following components/moulding compounds were used:
PA homopolymer 1 An extrusion moulding compound based on PA 6.12 from EVONIK Resource Efficiency GmbH (VESTAMID 22)
PA homopolymer 2 An extrusion moulding compound based on PA 10.10 from EVONIK Resource Efficiency GmbH (VESTAMID DS22)
PA homopolymer 3 An extrusion moulding compound based on PA 12 from EVONIK Resource Efficiency GmbH (VESTAMID L1901)
PEBA 1 An extrusion moulding compound based on PA 6.12 from EVONIK Resource Efficiency GmbH, containing 25% by weight of a bisamino-terminated polyether having a molar mass of 400 g/mol (Elastamin RP-405, Huntsman)
PEBA 2 An extrusion moulding compound based on PA 10.10 from EVONIK Resource Efficiency GmbH, containing 35.4% by weight of a bishydroxy-terminated polyether (polytetrahydrofuran) having a molar mass of 650 g/mol
PEBA 3 An extrusion moulding compound based on PA 12 from EVONIK Resource Efficiency GmbH, containing 29% by weight of a bishydroxy-terminated polyether (polytetrahydrofuran) having a molar mass of 1000 g/mol is
EVAL An EVOH from Kuraray with 27 mol % of ethylene (EVAL LA170B)
IM Impact modifier: Exxelor VA1803 (9%) +1% Lotader AX8900
Stabilizer Mixture of Irgafos and Irganox.
Adhesion promoter An extrusion moulding compound based on PA 6.12 from EVONIK Resource Efficiency GmbH (VESTAMID SX8002 or VESTAMID SX8080; SX8080 has the same indices as SX8002, but without plasticizer)

### EXAMPLE 1, MOULDING COMPOUNDS

The moulding compounds that follow were compounded in a Haake kneader (HAAKE Rheomix 600 OS) by mixing the components in the melt.

TABLE 1
Composition of the moulding compounds of Example 1.

| | | | Content | Content |
|---|---|---|---|---|
| Moulding | PA | | of PE | of CNTs |
| compound | homopolymer | PEBA | [% by wt.] | [% by wt.] |
| 1 | 1 | 0 | 0 | 0 |
| 11 | 1 | 0 | 0 | 3 |
| 12 | 1 | 1 | 4.25 | 0 |
| 13 | 1 | 1 | 4.25 | 3 |
| 14 | 0 | 1 | 25 | 0 |
| 15 | 1 | 1 | 21 | 0 |
| 2 | 2 | 0 | 0 | 0 |
| 21 | 2 | 0 | 0 | 3 |
| 22 | 2 | 2 | 4.25 | 0 |
| 23 | 2 | 2 | 4.25 | 3 |
| 24 | 0 | 2 | 35.4 | 0 |
| 3 | 3 | 0 | 0 | 0 |
| 31 | 3 | 0 | 0 | 3 |
| 32 | 3 | 3 | 4.25 | 0 |
| 33 | 3 | 3 | 4.25 | 3 |
| 34 | 3 | 3 | 2.15 | 0 |
| 35 | | 3 | 29 | 0 |

PEBA means PA copolymer, PE means polyether, CNT means carbon nanotubes;
the content of PE means the proportion by weight of the polyether in the moulding compound, without taking account of the mass of the CNTs;
the content of CNTs is the proportion by mass based on the overall moulding compound

Moulding compounds 13, 23 and 33 are in accordance with the invention.

### EXAMPLE 2, DETERMINATION OF THERMAL PROPERTIES

By means of DSC in accordance with ISO 11357 (Perkin-Elmer), at a rate of 20 K/min, the glass transition temperature T_{g} and the crystallite melting points Tₘ in the 1st heating run were determined, and the degree of crystallinity Xc was calculated from the determination of the enthalpy of fusion in the 2nd heating run.

TABLE 2
Determination of the thermal properties according to
Example 2; nd means that the value was not determined

| Moulding | T_{g} | Tₘ | X_{c} |
|---|---|---|---|
| compound | [° C.] | [° C.] | [%] |
| 1 | 41 | 215 | 38 |
| 11 | 39 | 216 | 45 |
| 12 | 37 | 216 | 37 |
| 13 | 39 | 216 | 44 |
| 14 | 43 | 0/163/197 | 32 |
| 15 | 38 | 0/184/195/206 | 31 |
| 2 | 41 | 200 | 41 |
| 21 | 37 | 198 | 45 |
| 22 | 37 | 200 | 43 |
| 23 | 42 | 198 | 43 |
| 24 | 42 | −23/186 | 32 |
| 3 | 38 | 178 | 32 |
| 31 | 40 | 179 | 37 |
| 32 | 37 | 179 | 36 |
| 33 | 40 | 179 | 36 |
| 34 | 40 | 177 | 32 |
| 35 | 35 | −22/167 | 24 |

It is observed in all cases that the degree of crystallinity Xc rises on addition of the carbon nanotubes to the base polymer. Moreover, it is observed in all cases that the crystallinity Xc can be lowered when a small portion of the base polymer is replaced by a PEBA. The moulding compounds according to the invention do not have a crystallite melting point below 50° C.; this is also true of moulding compound 34 that has a lower content of polyether.

### EXAMPLE 3, MANUFACTURE OF HOLLOW PROFILES

Five-layer pipes with an external diameter of 8 mm and a total wall thickness of 1 mm were produced by means of coextrusion on a multilayer pipe system from Bellaform.

The comparative example differs merely in the composition of the inner layer (layer I).

TABLE 3
Layer configuration of the hollow profiles according to Example 3

| inventive | | | | |
|---|---|---|---|---|
| Layer V | VESTAMID LX9002 | Outer layer | | 0.45 mm |
| Layer IV | Adhesion promoter, | Adhesion layer | | 0.1 mm |
| | outside | | | |
| Layer III | EVAL | Barrier layer | | 0.15 mm |
| Layer II | Adhesion promoter, | Adhesion layer | | 0.1 mm |
| | inside | | | |
| Layer I | Extrusion moulding | Inner layer | | 0.2 mm |
| | compound based on | | | |
| | PEBA 1 | | | |
| | Composition: | | | |
| | Moulding compound 13 | 89.5% | by wt. | |
| | IM | 10% | by wt. | |
| | Stabilizer | 0.5% | by wt. | |
| Comparison | | | | |
| Layer I | Extrusion moulding | Inner layer | | 0.2 mm |
| | compound based on PA | | | |
| | homopolymer 1 | | | |
| | Composition: | | | |
| | Moulding compound 11 | 89.5% | by wt. | |
| | IM | 10% | by wt. | |
| | Stabilizer | 0.5% | by wt. | |

### EXAMPLE 4: TESTS

Pipes from Example 3 were subjected to the following tests:
a) Tensile test (with MLT): The single- and multilayer pipes were tested in accordance with DIN EN ISO 527-1 at a takeoff speed of 100 mm/min. The test specimens had a length of about 200 mm, the clamped length was 100 mm and strain sensor spacing was 50 mm.
b) Impact tests: The impact resistance of the mono- and multilayer pipes was measured at 23° C. to DIN 73378.

The impact resistance of the mono- and multilayer pipes was measured at −25° C. to VWTL52435 with a drop hammer of mass 880 g.

The impact resistance of the mono- and multilayer pipes was measured at −40° C. to SAE J2260 with a drop hammer of mass 500 g.

For all tests, 10 specimens of length about 100 mm were analysed. The stress test was followed by a visual check for damage.
c) Separation test: The separation test was conducted with a Zwick BZ 2.5/TN1S tensile tester to which a tensile device and a rotating deflection roll made of metal are attached in order to be able to separate the individual layers of the test specimens from one another. The separation test in accordance with DIN EN ISO 2411 was used to determine the adhesion between two layers by measuring the force required to separate the two layers from one another. To this end, pipe sections of the multilayer pipes 20 cm in length were divided longitudinally into three portions using a cutting device.

Prior to starting measurement, calipers were used to measure the sample width repeatedly at different points and the average value was used for evaluation. The incipiently separated end of one layer was then held in a clamp which continuously pulled said layer from the second layer at an angle of 90° .

The layers were pulled apart at a test speed of 50 mm/min while, simultaneously, a diagram of the required force in newtons versus the displacement in millimeters was recorded. This diagram was used to determine, in the plateau region, the separation resistance in N/mm based on the width of the adherent contact area.
d) Fuel permeability: The permeation measurement was used to determine how much fuel per day and meter of pipe/square meter of the inner pipe area permeates through a fuel line in the case of static storage at 60° C. For this purpose, pipe sections of length 300 mm in each case were screwed at one end to a pressure-tight reservoir vessel and weighed, then filled with 300 ml of CM 15, and the second end was closed. These test specimens were stored in an explosion-protected heated cabinet with forced ventilation at 60° C. The filled pipes were weighed once again, in order to be able to determine the loss of mass and hence the permeated mass of fuel at particular time intervals. The effective permeation length was 285 mm.
e) Washout resistance: By means of the determination of washout, it was ascertained how many g/m² of the inner pipe surface in the form of soluble and insoluble constituents are extracted from the multilayer composite after exposure to fuel. For this purpose, a pipe section of length 2 m was filled completely with the CM15 test fuel and closed, and stored at 60° C. for 96 h. After cooling, the pipe was emptied into a beaker and rinsed with 20 ml of CM 15. The liquid obtained was stored at 23° C. for 24 h. Thereafter, the test liquid was filtered under reduced pressure at 23° C. and rinsed through with 20 ml of CM 15. The filtered medium was left to evaporate in a fume hood at room temperature. This gave the soluble extracts by means of weighing. The filter was dried at 40° C. for 24 h and weighed. The difference from the original weight of the filter was used to determine the insoluble extracts.

The test is considered to have been passed if less than 6 g/m² of soluble constituents and less than 0.5 g/m² of insoluble constituents have been washed out.
f) Performance of the heat ageing of the MLTs describe (heated air circulation cabinet, 200 h at 150° C. and 1 hat 170° C.)

In a heated air circulation cabinet, pieces of the corresponding mono- or multilayer pipes of length about 100 or 200 mm were stored at elevated temperatures for defined periods of time. It should be ensured here that the pipe pieces are freely suspended in the air circulation oven without touching one another or the metal surfaces.

The length of the pipe pieces depends on the subsequent mechanical testing. As described in b), test specimens of about 100 mm in length were used for the pipe impact tests. After storage at 150° C. for 200 h with subsequent conditioning under standard climatic conditions of 23° C./50% rel. humidity for >24 h, a pipe impact test was conducted as described in b). The pipe impact test was effected analogously on pipe pieces that had been stored at 170° C. for 1 h beforehand.
g) Determination of insulation resistance and alteration thereof by fuel storage with CM15, CE10 and FAM B at 60° C.

Electrical resistance was determined on at least three pipe sections of length 42 cm to SAE J2260-1996. For this purpose, the inner pipe surfaces were contacted at the pipe ends with plugs of defined length and diameter. Test voltages between 10 V and 500 V were used to measure electrical resistance within the range from 10² to 10¹⁴ Ω and converted using the interior pipe area between the plugs to the required surface resistivity having the unit “ohms per square”.

Thereafter, the pipe sections were screwed at one end to a reservoir vessel and weighed, then filled with 300 ml of test fuel (CM 15), and the second end was closed. The pipe is under the reservoir vessel, such that the inner pipe surface was completely filled with fuel during the storage and the electrical measurements. The inner layer was contacted via the metallic screw connections with support sleeves at the pipe ends, and the resistance was determined directly after the filling. The test specimens were stored in an explosion-protected heated cabinet with forced ventilation at 60° C. and, at regular intervals, cooled down to 23° C. and the change in electrical resistance was determined for a test time of about 1000 hours. In parallel with the electrical resistance, the absolute length of the free pipe cross section was determined with a measuring tape between the screw connections, and the change in length was determined with a dial gauge in the range of 0% to 5%.

The test is considered to have been passed if the resistance is determined to be less than 10⁶ ohms/area.

Composition of the test fuels CE 10 and CM 15 and FAM B are in the references of SAE J2260-1996; CM 15 corresponds to ASTM D471-15, “Reference Fuel I” (isooctane/toluene, methanol); FAM B corresponds to the test liquid of DIN 51604-2 (1984); CE10 corresponds to a mixture of “Fuel C” according to ASTM D471-15 plus 10±1% by volume of ethanol.

The results are shown in Table 4.

TABLE 4
Test results for the pipes according to Example 3

| Test | Inventive | Comparative |
|---|---|---|
| Ageing resistance at 150° C. for | no fracture | 10 out of 10 |
| 200 h (DIN 53497), then pendulum | | broken |
| impact to ISO 179-1 at RT | | |
| Cold impact at −25° C./880 g | no fracture | 1 out of 10 |
| | | broken |
| Cold impact at −40° C./500 g | no fracture | 2 out of 10 |
| | | broken |
| Washout resistance as per point e) | passed | not ascertained |
| Insulation resistance as per point g) | passed | failed |
| Fuel permeability as per point d) | 4.3 g/(m²*d) | not determined |

### EXAMPLE 5—MOULDING COMPOUNDS WITH DIFFERENT FILLER CONTENTS

First of all, a filler-containing masterbatch is produced with a Nanocyl twin-screw extruder, based on a polyether-modified polyamide (PA612.6T, ground powder) having a concentration of 10% CNTs.

Then the masterbatch is diluted in the twin-screw extruder with addition of polyamide, impact modifier, stabilizer and die. This produces moulding compounds having the constituents and filler contents shown in Table 5.

TABLE 5
Formulations

| Composition | 1 | 2 | 3 |
|---|---|---|---|
| % by weight of CNTs (based on total mass of | 3.68 | 4.91 | 7.36 |
| polyamide component and filler) | | | |
| Plasticyl masterbatch (10% by weight of CNTs) | 30 | 40 | 60 |
| Vestamid Htplus | 51.5 | 41.5 | 21.5 |
| Impact modifier | 15 | 15 | 15 |
| Stabilizer | 1.5 | 1.5 | 1.5 |
| Vestamid FG schwarz | 2 | 2 | 2 |

The moulding compounds are used to produce test specimens. For the notched impact test, these are injection-moulded/multipurpose specimens in dimensions of 170×10×4 mm³. For the electrical test, ribbons are extruded in thickness 1 mm.

Table 6 below shows the results of the notched impact tests and the electrical tests together with test conditions.

TABLE 6
Tests

| Composition | 1 | 2 | 3 |
|---|---|---|---|
| % by weight of CNTs (based on total | 3.68 | 4.91 | 7.36 |
| mass of polyamide component and | | | |
| filler) | | | |
| Notched impact resistance to ISO179 | 105.4 (P) | 102.31 (P) | 82.45 (P) |
| 1−eA at 23° C. (in kJ/m²) | | | |
| Specific resistivity in accordance with | 1.51E+13 | 3.45E+10 | 1.73E+05 |
| SAE J2260, measured on extruded | | | |
| ribbons (in ohm/square) | | | |

The decrease in notched impact resistance over and above 6% is clearly apparent. In addition, specific resistivity is too high below 2.5%.

1. A moulding compound comprising at least 50% by weight of a semicrystalline polyamide component and comprising a filler that imparts conductivity to the moulding compound,
wherein the moulding compound does not have a crystallite melting point (Tₘ) below 50° C.,
where the polyamide component comprises components A and B
A PA homopolymer of the PA X.Y or PA Z type, where X represents a diamine residue (DA), Y represents a dicarboxyl residue (DC), and Z represents an alpha,omega-amino acid residue;
B PA copolymer of the PA X′.Y′ type where X′ represents a diamine residue (DA′) and Y′ represents a dicarboxyl residue (DC′);
where some of the diamine residues (DA') are replaced by a polyether having at least two amino termini or at least two hydroxy termini;
where the proportion of polyether in the sum total of components A and B is between 0.5% and 15% by weight
and where the proportion of filler is from 2.5% to 6% by weight, based on the total mass of polyamide component and filler;
where up to 10 mol % of the PA homopolymer may be formed from other amide-forming units;
where up to 10 mol % of the diamine residues (DA′) may be replaced by a polyether having just one amino terminus or just one hydroxy terminus.

2. The moulding compound according to claim 1, wherein the PA copolymer of component B has a polyether content of from 8% to 30% by weight, based on the total mass of the PA copolymer.

3. The moulding compound according to claim 1, wherein the polyether has a number-average molecular weight Mₙ of not more than 5000 g/mol.

4. The moulding compound according to claim 1, wherein the chain lengths of the PA copolymer and of the PA homopolymer of the polyamide component differ from one another by an average of not more than 10% in relation to the number of carbon atoms in the amide-forming units, where the difference is based on the higher value of the chain lengths.

5. The moulding compound according to claim 1, wherein it has a degree of crystallinity lower than the degree of crystallinity of a mixture including the same components A and filler for increasing conductivity in equal amounts, where any further constituents of the moulding compound are likewise identical in identity and amount.

6. The moulding compound according to claim 1, wherein the moulding compound is free of plasticizers.

7. A hollow profile comprising the moulding compound according to claim 1.

8. A single-layer or multilayer hollow profiles having at least one layer consisting of a moulding compound according to claim 1.

9. The single-layer or multilayer hollow profiles according to claim 8, having at least one barrier layer.

10. The single-layer or multilayer hollow profiles according to claim 8, wherein layers arranged on the inside of the barrier layer in the hollow body are free of plasticizers.

11. A process for producing a moulding compound according to claim 1, wherein the individual constituents are mixed by melt mixing.

12. The process according to claim 11, wherein constituents A and B and the filler are mixed simultaneously with one another.

13. The moulding compound according to claim 2, wherein the polyether has a number-average molecular weight Mₙ of not more than 5000 g/mol.

14. The moulding compound according to claim 2, wherein the chain lengths of the PA copolymer and of the PA homopolymer of the polyamide component differ from one another by an average of not more than 10% in relation to the number of carbon atoms in the amide-forming units, where the difference is based on the higher value of the chain lengths.

15. The moulding compound according to claim 3, wherein the chain lengths of the PA copolymer and of the PA homopolymer of the polyamide component differ from one another by an average of not more than 10% in relation to the number of carbon atoms in the amide-forming units, where the difference is based on the higher value of the chain lengths.

16. The moulding compound according to claim 2, wherein it has a degree of crystallinity lower than the degree of crystallinity of a mixture including the same components A and filler for increasing conductivity in equal amounts, where any further constituents of the moulding compound are likewise identical in identity and amount.

17. The moulding compound according to claim 3, wherein it has a degree of crystallinity lower than the degree of crystallinity of a mixture including the same components A and filler for increasing conductivity in equal amounts, where any further constituents of the moulding compound are likewise identical in identity and amount.

18. The moulding compound according to claim 2, wherein the moulding compound is free of plasticizers.

19. A process for producing a moulding compound according to claim 2, wherein the individual constituents are mixed by melt mixing.

20. The process according to claim 19, wherein constituents A and B and the filler are mixed simultaneously with one another.
